(19) United States
(12) Patent Application Publication
(10) Pub. No.: US 2019/0291703 A1
(43) Pub. Date: Sep. 26, 2019

(54) AUTONOMOUS VEHICLE HAVING A MEANS OPERABLE THEREIN TO AUTOMATICALLY STOP THE VEHICLE WHEN A BODY BEGINS TO ENTER THE TRACK DIRECTION OF THE VEHICLE

(71) Applicant: James P. O'SULLIVAN, SR., Leesburg, VA (US)

(72) Inventor: James P. O'SULLIVAN, SR., Leesburg, VA (US)

(21) Appl. No.: 16/360,935

(22) Filed: Mar. 21, 2019

Related U.S. Application Data
(60) Provisional application No. 62/646,797, filed on Mar. 22, 2018.

(51) Int. Cl. B60T 7/12; G05D 1/00

(52) U.S. Cl. CPC B60T 7/12; G05D 1/0055

(57) ABSTRACT

An autonomous vehicle having a tether therein attached to at least one end thereof to a first point in the autonomous vehicle and at the other end thereof to a second and different point in the autonomous vehicle. The tether includes a slack region having a slack so that when the slack changes position due to a change in momentum of the moving autonomous vehicle, the tether acts on the second and different point attachment to stop the autonomous vehicle. Also provided is a method for stopping an autonomous vehicle. The method includes providing a tether, at least one end thereof attached to a first point in the autonomous vehicle, the other end thereof attached to a second and different point in the autonomous vehicle, wherein the tether includes a slack region having a slack so that when the slack changes position due to a change in momentum of the moving autonomous vehicle, the tether acts on the second and different point attachment to stop the autonomous vehicle.

### CROSS-REFERENCE TO RELATED APPLICATION

This application claims the benefit of Provisional Patent Application No. 62/646,797, filed Mar. 22, 2018, which application is incorporated herein by reference in its entirety and made a part hereof.

### FIELD

The present disclosure relates to an apparatus for and a method of automatically stopping an autonomous vehicle.

### BACKGROUND

Autonomous vehicles, including driverless vehicles, are currently being developed to avoid the disadvantages of manned vehicles, such as labor costs of drivers, accidents caused by inattentive, or otherwise impaired drivers, and inaccuracies in execution of driver tasks caused by variance between drivers, human limitations or other similar or related human factors. Some autonomous vehicles are under development that will communicate with a remote operator controlled control unit. Proposals have been made to provide such a remote unit with an emergency stop button.

Recently, a vehicle outfitted with a sensing system, was in autonomous mode with a human safety driver at the wheel but carrying no passengers when it struck a pedestrian. A preliminary investigation showed that the vehicle was moving around 40 miles per hour when it struck the pedestrian, who was walking with her bicycle on the street. The car did not appear to have slowed down before impact and the safety driver had shown no signs of impairment. The weather was clear and dry. Researchers working on autonomous technology have struggled with how to teach the systems to adjust for unpredictable human driving or behavior.

While there exists certain technology that will stop an autonomous vehicle and some or all its functions under most conditions, what is needed is an effective apparatus and method of automatically stopping an autonomous vehicle.

### SUMMARY

In one aspect, provided is an autonomous vehicle having a tether therein attached to at least one end thereof to a first point attachment in the autonomous vehicle and at the other end thereof to a second and different point attachment in the autonomous vehicle, the tether including a slack region having a slack, so that when the slack changes position due to a change in momentum of the moving autonomous vehicle, the tether acts on the second and different point attachment to stop the autonomous vehicle.

In one form, the second and different point attachment is structured and arranged to complete a circuit that acts to stop the vehicle.

In another form, the first point and the second point are located on a front and a back of a forward compartment of the autonomous vehicle, respectively, and on axially opposite sides of the compartment.

In another form, the change in momentum is deceleration and the slack moves forward toward the first point attachment.

Also presented is a method for stopping an autonomous vehicle, the method comprising providing a tether, at least one end thereof attached to a first point attachment in the autonomous vehicle, the other end thereof attached to a second and different point attachment in the autonomous vehicle, wherein the tether includes a slack region having a slack, so that when the slack changes position due to a change in momentum of the autonomous vehicle during operation of the vehicle, the second point attachment acts to stop the autonomous vehicle.

In another form, the second and different point attachment is structured and arranged to complete a circuit that that performs the step of stopping the vehicle.

In yet another form, the change in momentum is deceleration and the slack moves forward toward the first point attachment, applying a force to the second point attachment.

### BRIEF DESCRIPTION OF THE DRAWING

FIG. 1 presents a perspective view of an illustrative example of an autonomous vehicle, according to the present disclosure; and

FIG. 2 presents a method 100 for stopping an autonomous vehicle, according to the present disclosure.

### DETAILED DESCRIPTION

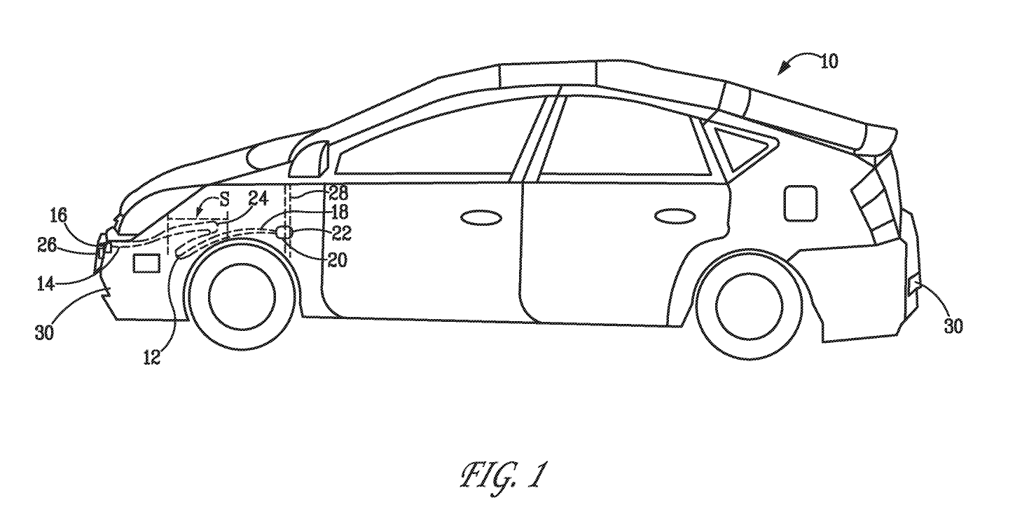

FIG. 1 provides an illustrative, non-exclusive example of an autonomous vehicle 10, according to the present disclosure. Autonomous vehicle 10 includes a tether 12 therein, such as in a compartment under the front hood, wherein at least one front portion 14 thereof is attached to a first point of attachment 16 in the autonomous vehicle 10. The other, rear portion 18 of tether 12 is attached to a second and different point of attachment 20 in the autonomous vehicle 10. In one form, the tether 12 is disposed within a compartment under the front hood of the autonomous vehicle 10, and the first point of attachment 16 is located at a point close to the front end 26 of the vehicle 10, and the second point of attachment 20 is located at or near what would be conventionally known as the firewall 28. The first and second points of attachment are generally in line with the axis of the vehicle 10, and on axially opposite sides of the compartment. Of course, the tether 12 could be located in a rear compartment of vehicle 10, if desired.

As shown, tether 12 includes a slack region S having a slack 24 so that when the slack 24 changes position due to a change in momentum of the moving autonomous vehicle 10, the second and different point attachment 20 completes the circuit 22 to stop the autonomous vehicle 10, such as by virtue of Newton's laws of motion. In this manner, when the vehicle 10 experiences a rapid deceleration, such as a braking action initiated by a driver or by an electronic sensor or the like, slack 24 continues forward due to its inertia and pulls the rear portion of the tether 12 away from the second point of attachment 20. The force generated by this action can be used to activate a switch to complete circuit 22, which then activates the braking system of the vehicle 10, bringing it to a complete stop. The slack can be assisted by an extensible elastic member, e.g. a spring, or a rubber or rubber-like member attached to and supporting the slack.

In some embodiments, a vehicle sensor system (not shown), which may include sensors 30, may initiate the slowing down of the autonomous vehicle 10 and/or initiate a maximum force, such as a panic force, which forces slack 24 forward, pulling against the rear portion 18 of tether 12 to activate a switch and complete circuit 22, to stop the vehicle in the shortest distance.

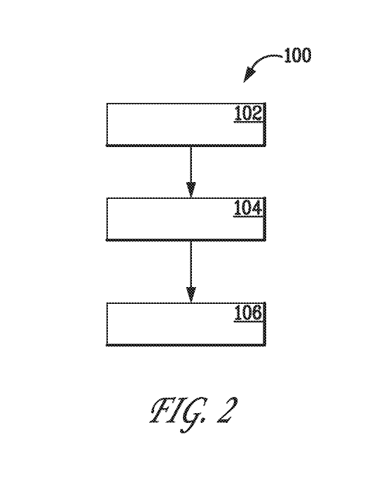

Referring now to FIG. 2, in another aspect, provided is a method 100 for stopping an autonomous vehicle. The method 100 includes the step of providing a tether 102, at least one end thereof attached to a first point of attachment in the autonomous vehicle, the other end thereof attached to a second and different point of attachment in the autonomous vehicle, wherein the tether includes a slack region having a slack so that when the slack changes position due to a change in momentum of the autonomous vehicle during operation of the vehicle, the second point attachment serves to perform the step of stopping the autonomous vehicle 104, such as by virtue of Newton's laws of motion.

In some embodiments, the second and different point attachment is structured and arranged to perform the step of completing a circuit 106 that serves to stop the vehicle.

In one form, the change in momentum is deceleration and the slack moves forward toward the first point attachment, applying a force to the second point attachment.

To clarify for the purposes of the instant disclosure, the levels of autonomy are a progression of self-driving features that SAE International has outlined. These levels range from no self-driving features at all through fully autonomous driving. They are as follows:

Level 0: No automation. This includes cars equipped with regular cruise control. The ability to maintain a speed that the driver sets is not autonomous. It is still up to the driver to change speed if the car catches up to a slow-moving vehicle.

Level 1: Driver assistance required. Adaptive cruise control falls into this category. When you catch up to that slow-moving vehicle, the car will automatically slow down to match its speed with no intervention from you. Lane keeping assistance falls into this category as well, as the car will gently guide you back into your lane as you start to cross the line. At Level 1, the driver still needs to maintain full situational awareness and control of the vehicle.

Level 2: Partial automation options available. These vehicles will manage both your speed and your steering under certain conditions, such as highway driving. They will match your speed to the speed of traffic ahead of you and follow the curves in the road in ideal conditions. But the driver must still pay attention to driving conditions at all times and take over immediately if the conditions exceed the system's limitations, of which there are many. These cars can only drive themselves at certain times under certain conditions.

Level 3: Conditional Automation. The car, rather than the driver, takes over actively monitoring the environment when the system is engaged. Such cars can take over the tedious job of creeping through highway traffic jams at speeds below a certain modest level (e.g., 37 MPH). However, human drivers must be prepared to respond to a “request to intervene,” as SAE International calls it. In other words, once the conditions under which Level 3 autonomous driving is possible no longer exist, such as traffic clearing and speeds exceeding the certain level, the driver is required to take over. This is arguably the stickiest level of autonomy, since drivers will be called on to take over when they have not been paying attention to the road for a while.

Level 4: High automation. Self-driving cars will be able to handle most “dynamic driving tasks,” to use SAE International's terminology. In other words, a Level 4 car can handle most normal driving tasks on its own, but will still require driver intervention from time to time, during poor weather conditions, for example, or other unusual environments. Level 4 cars will generally do the driving for you, but will still have a steering wheel and pedals for a human driver to take over when needed.

Level 5: Full automation. Humans are nothing but cargo that tell the car where to take them. The car can drive itself anytime, anywhere, under any conditions. Any human intervention in the driving at all is not Level 5.

The motion of an automobile can be explained and described by physical principals discovered over 300 years ago by Sir Isaac Newton. Newton, in 1686, presented his three laws of motion in the “Principia Mathematica Philosophiae Naturalis.”

Newton's first law states that every object will remain at rest or in uniform motion in a straight line unless compelled to change its state by the action of an external force. This is normally taken as the definition of inertia. The key point here is that if there is no net force acting on an object (if all the external forces cancel each other out) then the object will maintain at a constant velocity, such as when the slack 24 in tether 12 is moving at the same speed as the autonomous vehicle 10. If that velocity is zero, then the object remains at rest. If an external force is applied, the velocity will change because of the force.

The second law explains how the velocity of an object changes when it is subjected to an external force. The law defines a force to be equal to a change in momentum (mass times velocity) per change in time. Newton also developed the calculus of mathematics, and the “changes” expressed in the second law are most accurately defined in differential forms. For an object with a constant mass m, the second law states that the force F is the product of an object's mass and its acceleration (or deceleration).

For an external applied force, the change in velocity depends on the mass of the object. A force will cause a change in velocity; and likewise, a change in velocity will generate a force. In the present case, the force generated by a deceleration of autonomous vehicle 10 acts to pull against a rear portion of tether 12, and activate a switch, such as completing circuit 22, which thereby activates the braking system of the vehicle.

The third law states that for every action (force) in nature there is an equal and opposite reaction. In other words, if object A exerts a force on object B, then object B also exerts an equal force on object A. As such, the forces are exerted on different objects.

In the present disclosure, the illustrative, non-exclusive examples have been discussed and/or presented in the context of a flow diagram, or flow chart, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

### INDUSTRIAL APPLICABILITY

The systems and methods disclosed herein are applicable to the autonomous vehicle industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. An autonomous vehicle having a tether therein attached to at least one end thereof to a first point attachment in the autonomous vehicle and at the other end thereof to a second and different point attachment in the autonomous vehicle, the tether including a slack region having a slack, so that when the slack changes position due to a change in momentum of the moving autonomous vehicle, the tether acts on the second and different point attachment to stop the autonomous vehicle.

2. The autonomous vehicle of claim 1, wherein the second and different point attachment is structured and arranged to complete a circuit that acts to stop the vehicle.

3. The autonomous vehicle of claim 1, wherein the first point and the second point are located on a front and a back of a forward compartment of the autonomous vehicle, respectively, and on axially opposite sides of the compartment.

4. The autonomous vehicle of claim 1, wherein the change in momentum is deceleration and the slack moves forward toward the first point attachment.

5. A method for stopping an autonomous vehicle, the method comprising:
providing a tether, at least one end thereof attached to a first point attachment in the autonomous vehicle, the other end thereof attached to a second and different point attachment in the autonomous vehicle,
wherein the tether includes a slack region having a slack, so that when the slack changes position due to a change in momentum of the autonomous vehicle during operation of the vehicle, the second point attachment acts to stop the autonomous vehicle.

6. The method of claim 5, wherein the second and different point attachment is structured and arranged to complete a circuit that that performs the step of stopping the vehicle.

7. The method of claim 5, wherein the change in momentum is deceleration and the slack moves forward toward the first point attachment, applying a force to the second point attachment.
